(19) United States
(12) Patent Application Publication
(10) Pub. No.: US 2026/0001312 A1
(43) Pub. Date: Jan. 1, 2026

(54) SUBSTRATE SEPARATION APPARATUS AND CONTROL METHOD THEREOF

(71) Applicant: ZEUS CO., LTD., Hwaseong-si (KR)

(72) Inventors: Sung Won MO, Hwaseong-si (KR); Seung Hoon LEE, Hwaseong-si (KR); Heung Soo HAN, Hwaseong-si (KR); Jin Uk KIM, Hwaseong-si (KR); Yu Jin PARK, Hwaseong-si (KR)

(73) Assignee: ZEUS CO., LTD., Hwaseong-si (KR)

(21) Appl. No.: 19/239,458

(22) Filed: Jun. 16, 2025

(30) Foreign Application Priority Data
Jun. 26, 2024 (KR) 10-2024-0083530

(51) Int. Cl. B32B 43/00

(52) U.S. Cl. CPC B32B 43/006; B32B 2309/72

(57) ABSTRACT

The present invention relates to a substrate separation apparatus, and the substrate separation apparatus includes a separation member (310) that enters a bonded portion (12) of a bonded substrate (10) in which a first substrate (11) and a second substrate (13) are bonded, and forms a crack, a sensor module (200) configured to photograph the bonded substrate (10) and the separation member (310) to obtain measurement values corresponding to distances from the sensor module (200) to the bonded substrate (10) and the separation member (310), and a processor (100) configured to move the separation member (310) to a height of the bonded portion (12) on the basis of the measurement values.

### CROSS-REFERENCE TO RELATED APPLICATION

This application claims priority to and the benefit of Korean Patent Application No. 10-2024-0083530, filed on Jun. 26, 2024, the disclosure of which is incorporated herein by reference in its entirety.

### BACKGROUND

### 1. Field of the Invention

The present invention relates to a substrate separation apparatus for separating a bonded substrate into individual substrates using a separation member such as a blade or the like, and a control method thereof.

### 2. Discussion of Related Art

Recently, in order to increase productivity and lower manufacturing costs in a semiconductor manufacturing process, a diameter of a substrate such as a wafer has been increasing and a thickness thereof has been decreasing.

It is easy for a substrate with a large diameter and small thickness to be warped or damaged during a transferring or surface polishing process.

In order to prevent warping or damage to a large and thin substrate during a transferring or polishing process, a process in which a carrier substrate is bonded to a device substrate to form a bonded substrate, the bonded substrate is transferred or polished, and then the carrier substrate is separated from the device substrate in the bonded substrate may be performed.

A substrate separation apparatus for separating a carrier substrate from a device substrate includes a separation member (e.g., a blade) that enters one side of a bonded portion (or a boundary surface) between the carrier substrate and the device substrate to cause a crack, and the substrate separation apparatus separates the carrier substrate by suctioning the carrier substrate and gradually lifting the carrier substrate from a portion in which the crack has occurred to expand the crack to an end of an opposite side of the bonded portion (or the boundary surface).

In this case, in order to improve a yield and work speed of a substrate separation operation, a technology for rapidly finding an exact location of the bonded portion (or the boundary surface) to allow entry of the separation member for rapid substrate separation without damaging to the carrier substrate or device substrate, and preventing damage to an entry portion (e.g., an entry surface) as much as possible (e.g., not rough but smooth) when a separation member enters a bonded portion (or a boundary surface) is required.

The related art of the present invention is disclosed in Korean Laid-open Patent Publication No. 10-2014-0033327 (published on Mar. 18, 2014, title of the invention: “METHOD FOR SEPARATING PRODUCT SUBSTRATE FROM CARRIER SUBSTRATE”).

### SUMMARY OF THE INVENTION

The present invention is directed to providing a substrate separation apparatus for rapidly separating a bonded substrate into individual substrates without damaging to the bonded substrate using a separation member such as a blade or the like to improve a yield and work speed of a substrate separation operation, and a control method thereof.

According to an aspect of the present invention, there is provided a substrate separation apparatus, which includes a separation member (310) that enters a bonded portion (12) of a bonded substrate (10) in which a first substrate (11) and a second substrate (13) are bonded, and forms a crack, a sensor module (200) configured to photograph the bonded substrate (10) and the separation member (310) to obtain measurement values corresponding to distances from the sensor module (200) to the bonded substrate (10) and the separation member (310), and a processor (100) configured to move the separation member (310) to a height of the bonded portion (12) on the basis of the measurement values, wherein the processor (100) sets a value, which is greater than a value obtained by adding an already known thickness (d1) of the second substrate (13) to a step difference (Δt), which is a height difference between the bonded substrate (10) and the separation member (310), and smaller than a value obtained by adding the already known thickness (d1) of the second substrate (13) and an already known thickness (d2) of the bonded portion (12) to the step difference (Δt), to be an entry height, and moves the separation member (310) thereto.

The processor (100) may calculate the step difference (Δt) on the basis of the measurement values corresponding to the distances from the sensor module (200) to the bonded substrate (10) and the separation member (310).

In order to form the crack, the processor (100) may move the separation member (310) to the height of the bonded portion (12) and then move the separation member (310) toward the bonded portion (12).

The processor (100) may analyze a shape of an image of the separation member (310) captured through the sensor module (200), and when damage to the separation member (310) occurs, immediately stop the entry of the separation member (310).

The processor (100) may simultaneously photograph the bonded substrate (10) and the separation member (310) through the sensor module (200) and calculate the step difference (Δt) between the bonded substrate (10) and the separation member (310), and at the same time, determine whether a blade of the separation member (310) is damaged.

In order to calculate the step difference (Δt) between the bonded substrate (10) and the separation member (310), and at the same time, determine whether a blade of the separation member (310) is damaged, the processor (100) may move the separation member (310) in a first direction, which is a direction toward the bonded substrate (10), by a distance that allows the sensor module (200) to detect the separation member (310) and the bonded substrate (10) simultaneously, and perform line scan measurement on the bonded substrate (10) and the separation member (310) while moving the sensor module (200) in a second direction crossing the first direction in a plan view.

According to another aspect of the present invention, there is also provided a control method of a substrate separation apparatus, which includes photographing, by a processor (100), a bonded substrate (10) and a separation member (310) through a sensor module (200) in order to measure distances from the sensor module (200) to the bonded substrate (10) in which a first substrate (11) and a second substrate (13) are bonded and the separation member (310), setting, by the processor (100), on the basis of the measured distances from the sensor module (200) to the bonded substrate (10) and the separation member (310), a value, which is greater than a value obtained by adding an already known thickness (d1) of the second substrate (13) to a step difference (Δt), which is a height difference between the bonded substrate (10) and the separation member (310) and smaller than a value obtained by adding the already known thickness (d1) of the second substrate (13) and an already known thickness (d2) of a bonded portion (12) to the step difference (Δt), to be an entry height, and moving the separation member (310) to a height of the bonded portion (12) of the bonded substrate (10), and moving, by the processor (100), the separation member (310) in a direction of the bonded portion (12) and forming a crack in the bonded portion (12).

After measuring the distances from the sensor module (200) to the bonded substrate (10) and the separation member (310), the processor (100) may calculate the step difference (Δt) on the basis of the measurement values corresponding to the distances from the sensor module (200) to the bonded substrate (10) and the separation member (310).

After the photographing of the separation member (310), the processor (100) may analyze a shape of an image of the separation member (310) captured through the sensor module (200), and when damage to the separation member (310) occurs, immediately stop the entry of the separation member (310).

In the photographing of the separation member (310), the processor (100) may simultaneously photograph the bonded substrate (10) and the separation member (310) through the sensor module (200) and calculate the step difference (Δt) between the bonded substrate (10) and the separation member (310), and at the same time, determine whether a blade of the separation member (310) is damaged.

After the photographing of the separation member (310), in order to calculate the step difference (Δt) between the bonded substrate (10) and the separation member (310), and at the same time, determine whether a blade of the separation member (310) is damaged, the processor (100) may move the separation member (310) in a first direction, which is a direction toward the bonded substrate (10), by a distance that allows the sensor module (200) to detect the separation member (310) and the bonded substrate (10) simultaneously, and perform line scan measurement on the bonded substrate (10) and the separation member (310) while moving the sensor module (200) in a second direction crossing the first direction in a plan view.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an exemplary diagram illustrating a schematic configuration of a substrate separation apparatus according to one embodiment of the present invention;

FIG. 2 is an exemplary diagram illustrating enlarged side surfaces of a bonded substrate and a separation member in FIG. 1;

FIG. 3 is an exemplary diagram illustrating the separation member in FIG. 1 when viewed from above;

FIGS. 4A to 4C are exemplary diagrams for describing an operation of determining whether a blade of the separation member is damaged in FIG. 1;

FIGS. 5A and 5B are exemplary diagrams for describing the types of damage to the blade of the separation member in FIGS. 4A and 4B; and

FIG. 6 is a flowchart for describing a substrate separation method according to one embodiment of the present invention.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

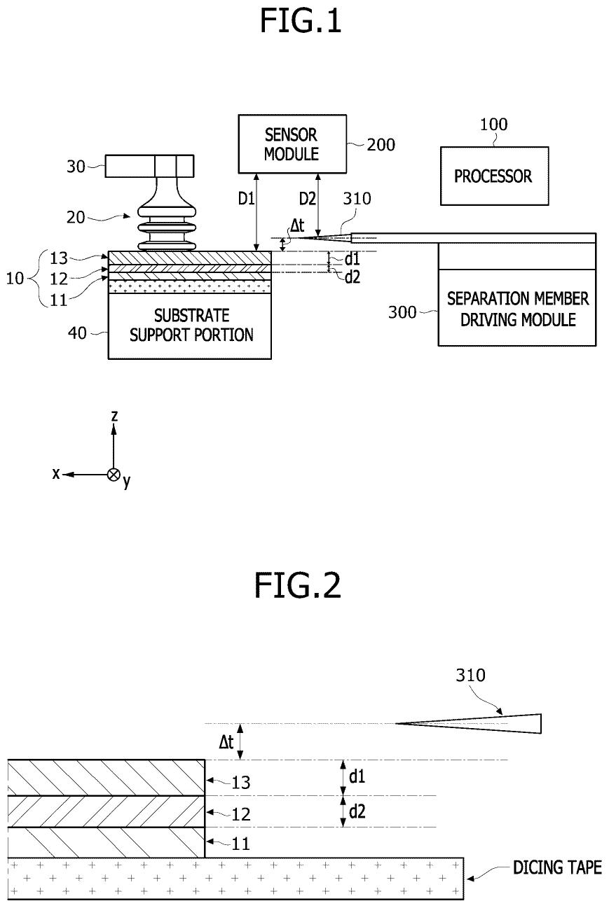

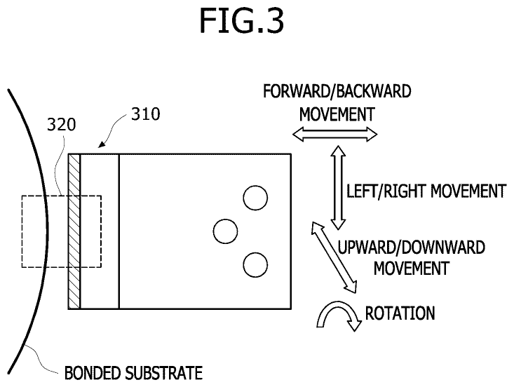

FIG. 1 is an exemplary diagram illustrating a schematic configuration of a substrate separation apparatus according to one embodiment of the present invention. FIG. 2 is an exemplary diagram illustrating enlarged side surfaces of a bonded substrate and a separation member in FIG. 1. FIG. 3 is an exemplary diagram illustrating the separation member in FIG. 1 when viewed from above.

As illustrated in FIG. 1, the substrate separation apparatus according to the embodiment of the present invention includes a processor 100, a sensor module 200, and a separation member driving module 300.

Referring to FIG. 1, the substrate separation apparatus according to the embodiment of the present invention separates a second substrate (e.g., a carrier substrate) 13 bonded to a first substrate (e.g., a device substrate) 11.

For example, the first substrate 11 may be a device substrate on which microcircuits are formed on a surface thereof and diced in units of semiconductor chips, and the second substrate 13 may be a carrier substrate for preventing warping or damage to the first substrate 11.

In this case, a planar shape of the second substrate 13 may be circular.

Adhesive tape (dicing tape) for support may be attached to a lower surface of the first substrate 11, and the adhesive tape may be flexibly bent and has a substantially circular planar shape.

A substrate support portion 40 may move up or down while suctioning and fixing the bonded substrate 10.

A separation member 310 (e.g., a blade, a laser, etc.) may enter a bonded portion 12 between the first substrate 11 and the second substrate 13 from one side of the bonded substrate 10, that is, one side of any one of the first substrate 11 and the second substrate 13, to form a crack.

A point at which the crack starts on any one side of a bonded surface (i.e., a boundary surface or the bonded portion 12) of the bonded substrate on which the first substrate 11 and the second substrate 13 are bonded may be called a separation initiation point.

Hereinafter, in the present embodiment, description will be made assuming that the separation member 310 is a blade.

The separation member 310 (i.e., the blade) may horizontally move (extend) at the same height as a height of the boundary surface (or the bonded portion 12) between the first substrate 11 and the second substrate 13.

In this case, a tip of the blade may be directed toward one side of the boundary surface (or the bonded portion 12) between the first substrate 11 and the second substrate 13.

A lifting portion 30 suctions and pulls the second substrate 13 upward using a plurality of suction portions 20 so that the second substrate 13 is separated from the first substrate 11 while the bonded substrate 10 is supported by the substrate support portion 40.

The lifting portion 30 is disposed above the second substrate 13.

The plurality of suction portions 20 suction and lift the second substrate 13 upward so that the crack between the first substrate 11 and the second substrate 13 expands and the second substrate 13 is separated from the first substrate 11, and the bonded substrate is separated in a method in which the separation member 310 (i.e., the blade) is used to enter the bonded portion 12 between the first substrate 11 and the second substrate 13 from one side of the bonded substrate 10, that is, one side of any one of the first substrate 11 and the second substrate 13, so that the portion (i.e., from the separation initiation point) in which the crack has been formed is first gradually lifted so that the crack is expanded to an opposite side.

For reference, in the drawing illustrated in FIG. 1, the separation member 310 (i.e., the blade) is illustrated as having a needle shape because a shape of the separation member 310 (i.e., the blade) is illustrated when viewed from the side, and referring to FIG. 3, which illustrates the shape of the separation member 310 (i.e., the blade) when viewed from above, the separation member 310 (i.e., the blade) may be formed in a planar shape.

The sensor module 200 may be provided on the bonded substrate 10, which is disposed on the substrate support portion 40, and the separation member 310.

The sensor module 200 may scan and capture images of the bonded substrate 10 and the separation member 310.

The sensor module 200 may photograph the bonded substrate 10 and the separation member 310 in the form of a top view from above the bonded substrate 10 and the separation member 310 to measure a distance (interval) between the bonded substrate 10 and the separation member 310.

For example, the sensor module 200 may obtain the distance (interval) between the bonded substrate 10 and the separation member 310 on the basis of measurement values obtained by simultaneously photographing the bonded substrate 10 and the separation member 310 from above the bonded substrate 10 and the separation member 310. In another embodiment, the sensor module 200 may obtain the distance (interval) between the bonded substrate 10 and the separation member 310 by individually photograph each of the bonded substrate 10 and the separation member 310 from above each of the bonded substrate 10 and the separation member 310.

The sensor module 200 may measure a distance from top of each of the bonded substrate 10 and the separation member 310 to the sensor module 200.

The sensor module 200 may be implemented to be mechanically movable in an x-axis direction and a y-axis direction according to the embodiment, and may additionally be implemented to be movable in a z-axis direction.

The sensor module 200 may measure a distance from an upper surface of the bonded substrate 10 (i.e., an upper surface of the second substrate 13) to the sensor module 200, and a distance from an upper surface of the separation member 310 (i.e., the blade) to the sensor module 200. That is, the sensor module 200 may measure a step difference (i.e., a height difference) between the bonded substrate 10 and the separation member 310 (i.e., the blade).

The sensor module 200 may include a laser sensor, a camera sensor (vision sensor), an infrared sensor, etc.

As illustrated in FIG. 3, the separation member driving module 300 may move the separation member 310 (i.e., the blade) forward/rearward, upward/downward, or laterally (in left/right direction), and rotate the separation member 310 (i.e., the blade) by a specified angle (e.g., 20 degrees).

The separation member driving module 300 may control the movement (or operation) of the separation member 310 (i.e., the blade) in an electric manner under the control of the processor 100.

The processor 100 may control the separation member driving module 300 to rapidly find a height of the separation member 310 (i.e., the blade) (e.g., a height to the upper surface of the separation member 310 that is calculated based on the distance from the sensor module 200 to the upper surface of the separation member 310) and match the height of the separation member 310 (i.e., the blade) to the height of the bonded portion 12 (or the boundary surface).

Referring to FIG. 2, when the bonded substrate 10 is loaded into the substrate separation apparatus, the processor 100 moves the separation member 310 (i.e., the blade) to a specified position (e.g., a range of a measurement position 320), and calculates a step difference (i.e., a height difference) Δt between the bonded substrate 10 and the separation member 310 (i.e., the blade) through the sensor module 200.

For example, the processor 100 may measure a distance D1 from the upper surface of the bonded substrate 10 to the sensor module 200 and a distance D2 from the upper surface of the separation member 310 (i.e., the blade) to the sensor module 200 through the sensor module 200, and calculate the step difference (i.e., the height difference) Δt between the bonded substrate 10 and the separation member 310 (i.e., the blade). In this case, since the shape and thickness of the separation member 310 (i.e., the blade) are already known values, it is possible to accurately calculate the step difference (i.e., the height difference) Δt regardless of the measurement position on the upper surface of the separation member 310 (i.e., the blade).

The processor 100 may set a position (height), which is greater than a value obtained by adding an already known thickness d1 of the second substrate 13 to the measured step difference Δt and smaller than a value obtained by adding the already known thickness d1 of the second substrate 13 and an already known thickness d2 of the boundary region (i.e., the bonded portion 12) to the measured step difference Δt, as an entry position (height), adjust the separation member 310 (i.e., the blade) to be the entry position (height), and then move the separation member 310 (i.e., the blade) in the x-axis direction to enter into a side surface (i.e., the bonded portion 12) of the bonded substrate 10.

The processor 100 may analyze a shape of the image of the separation member 310 (i.e., the blade) captured through the sensor module 200 to determine whether the blade is damaged.

The processor 100 may calculate a step difference between the second substrate 13 and the separation member 310 through the sensor module 200, and at the same time, determine whether the blade is damaged, or may first determine (or measure) whether the blade is damaged, and when it is determined that there is no damage to the blade, calculate the step difference between the second substrate 13 and the separation member 310. In another embodiment, the processor 100 may first calculate the step difference between the second substrate 13 and the separation member 310 and then determine whether (or measure) the blade is damaged. In still another embodiment, the determination of whether the blade is damaged may additionally be performed when the separation member 310 enters the bonded portion 12 and then moves in an opposite direction of the x-axis direction (see FIG. 3) (i.e., in a direction away from the bonded portion 12).

In particular, referring to FIG. 3, the processor 100 may set a region of the separation member 310 (i.e., the blade) that first comes into contact with the bonded substrate 10 as the measurement position 320, determine whether the blade of the separation member 310 is damaged, and calculate the step difference (i.e., the height difference) Δt between the bonded substrate 10 and the separation member 310.

When damage to the separation member 310 (i.e., the blade) occurs, damage to the bonded substrate 10 may occur when the separation member 310 (i.e., the blade) enters the boundary region (i.e., the bonded portion 12) of the bonded substrate 10, and thus the processor 100 immediately stops the entry of the separation member 310 (i.e., the blade).

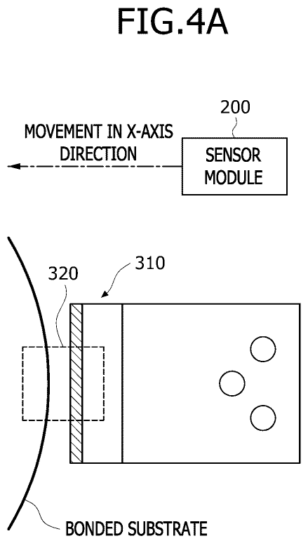

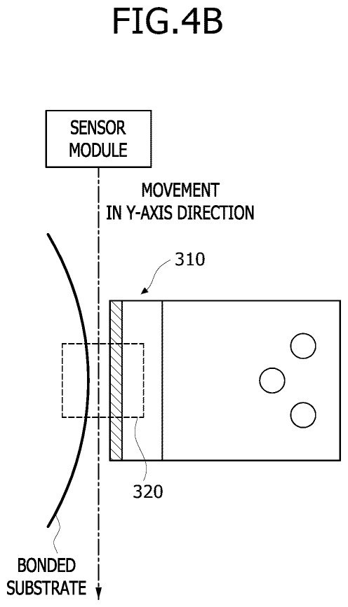

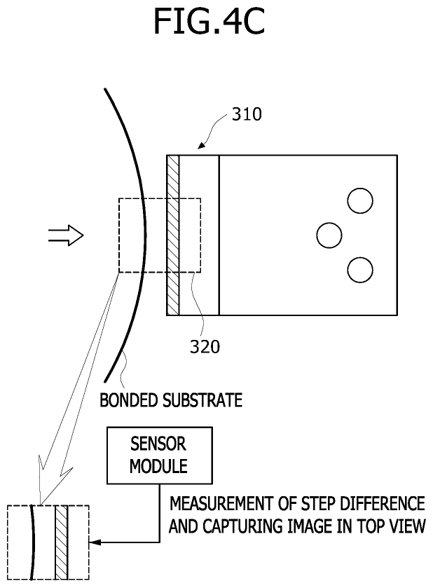

Hereinafter, the operation of determining whether the blade of the separation member 310 is damaged in more detail will be described with reference to FIGS. 4A to 4C.

FIGS. 4A to 4C are exemplary diagrams for describing the operation of determining whether the blade of the separation member 310 is damaged in FIG. 1.

Referring to FIGS. 4A to 4C, when the bonded substrate 10 is loaded into the substrate separation apparatus, the processor 100 moves the separation member 310 (i.e., the blade) in the direction of the bonded substrate 10 (i.e., the x-axis direction) (see FIG. 4A).

In this case, the separation member 310 (i.e., the blade) should be moved within the range of the measurement position 320, but should not come into contact with the bonded substrate 10.

Here, the range of the measurement position 320 may correspond to a sensing range of the sensor module 200, and the range of the measurement position 320 is not limited to a specific range and may be expanded or reduced.

Further, the measurement position 320 should include a position at which the distance between the bonded substrate 10 and the separation member 310 (i.e., the blade) is the smallest (i.e., a position at which the blade first enters the bonded substrate 10).

Therefore, the processor 100 may adjust a movement distance of the sensor module 200 in the x-axis direction so that both the bonded substrate 10 and the separation member 310 (i.e., the blade) may be included within the range of the measurement position 320. In this case, the movement distance in the x-axis direction may be set based on information on an already known size of the bonded substrate 10.

When the movement of the sensor module 200 in the x-axis direction is completed, the processor 100 moves the sensor module 200 in the y-axis direction and performs line scan measurement (see FIGS. 4B and 4C). In this case, the processor 100 matches a movement speed and a scan speed when performing line scan.

The processor 100 extracts an image of the blade on the basis of a value (data) obtained by performing the line scan measurement, and analyzes the extracted image of the blade to determine whether the blade is damaged. In this case, the range of determination of whether the blade is damaged may be preset.

In addition, the processor 100 may use the line scan measurement value (data) to obtain (calculate) the step difference (i.e., the height difference) Δt between the bonded substrate 10 and the separation member 310 (i.e., the blade) at the position at which the distance between the bonded substrate 10 and the separation member 310 (i.e., the blade) is the smallest.

For reference, the step difference Δt may vary according to the size or thickness of the bonded substrate 10.

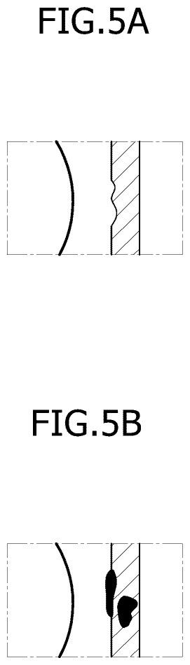

FIGS. 5A and 5B are exemplary diagrams for describing the types of damage to the blade of the separation member in FIGS. 4A to 4C.

Damage to the blade of the separation member 310 may include damage such as the blade breaking and damage such as adhesive being applied to the blade. For example, when the separation member 310 (i.e., the blade) enters the boundary region (i.e., the bonded portion 12) of the bonded substrate 10, damage such as adhesive (or dirt) being applied to the blade may occur or damage such as the blade breaking may occur.

Accordingly, as described with reference to FIGS. 4A to 4C, when the bonded substrate 10 is loaded into the substrate separation apparatus, the processor 100 moves the separation member 310 (i.e., the blade) within a specified range of the measurement position 320 in the direction of the bonded substrate 10 (i.e., the x-axis direction), and then moves the sensor module 200 to perform line scan measurement within the specified range of the measurement position 320.

When the line scan measurement is completed, the processor 100 extracts an image of the blade on the basis of a value (data) obtained by performing the line scan measurement, and analyzes the extracted image of the blade.

Through the analysis of the extracted image of the blade, it is determined whether damage such as blade breaking as illustrated in FIG. 5A and damage such as adhesive being applied to the blade as illustrated in FIG. 5B have occurred.

As illustrated in FIG. 5B, for example, the damaged blade may be an unbroken blade to which adhesive is applied. In this case, a criterion of the damaged blade based on the degree of adhesive applied to the blade may vary according to a user. As another example, the damaged blade may be a broken blade to which adhesive is applied. In this case, a method of determining the broken blade to which adhesive is applied may include setting a normal range of image data (e.g., the shape of the blade to which adhesive is applied, the range to which adhesive is applied, the thickness, etc.) as a reference value when adhesive is applied to an unbroken blade, and comparing a measurement value obtained by measuring the image of the blade through the sensor module 200 with a preset reference value to determine whether the blade itself is damaged.

In this case, referring to FIG. 5B, the adhesive may be applied to a front portion of the blade (i.e., a portion in a direction in which the bonded substrate 10 is present) or may be applied to a surface of the blade, and the processor 100 may determine which portion of the blade is damaged by the applied adhesive by analyzing the image of the blade.

Accordingly, when it is determined that there is damage to the blade of the separation member 310 (i.e., the blade), the processor 100 may automatically stop (terminate) the entry of the separation member 310 (i.e., the blade), or may output an alarm to the user and then stop or continue the operation according to the user's determination.

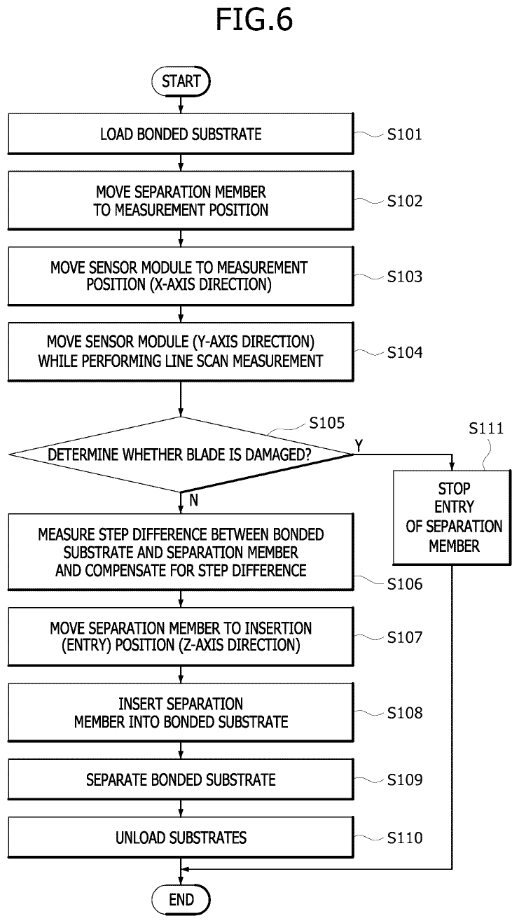

FIG. 6 is a flowchart for describing a substrate separation method according to one embodiment of the present invention.

Referring to FIG. 6, when a bonded substrate 10 is loaded into a substrate separation apparatus (S101), a processor 100 moves a separation member 310 (i.e., a blade) to a measurement position 320 in an x-axis direction of (i.e., a direction in which the bonded substrate 10 is present) (S102).

In this case, the processor 100 moves the separation member 310 (i.e., the blade) within a range of the measurement position 320, but within a range in which the separation member 310 (i.e., the blade) does not come into contact with the bonded substrate 10. Further, the measurement position 320 should include a position at which a distance between the bonded substrate 10 and the separation member 310 (i.e., the blade) is the smallest (i.e., a position at which the blade first enters the bonded substrate 10).

The processor 100 moves the sensor module 200 in the x-axis direction to correspond to the measurement position 320 (S103).

When the movement of the sensor module 200 in the x-axis direction is completed, the processor 100 moves the sensor module 200 in a y-axis direction and performs line scan measurement (S104).

In this case, the processor 100 matches a movement speed and a scan speed when performing line scan.

The processor 100 extracts an image of the blade on the basis of a value (data) obtained by performing the line scan measurement, and determines whether the blade is damaged on the basis of the extracted image of the blade (S105).

When damage to the separation member 310 (i.e., the blade) occurs (“Y” in S105), damage to the bonded substrate 10 may occur when the separation member 310 (i.e., the blade) enters a boundary region (i.e., a bonded portion 12) of the bonded substrate 10, and thus the processor 100 immediately stops (ends) the entry of the separation member 310 (i.e., the blade) (S111).

However, when damage to the separation member 310 (i.e., the blade) does not occur (“N” in S105), the processor 100 uses the line scan measurement value (data) to obtain (calculate) a step difference (i.e., a height difference) Δt at a position at which a distance between the bonded substrate 10 and the separation member 310 (i.e., the blade) is smallest, and calculates the position (height) in a z-axis direction for inserting the separation member 310 (i.e., the blade) into the bonded substrate 10 while compensating for the step difference Δt (S106).

When the position (height) in the z-axis direction for inserting the separation member 310 (i.e., the blade) into the bonded substrate 10 while compensating for the step difference Δt is calculated, the processor 100 moves the separation member 310 (i.e., the blade) to the position (height) in the z-axis direction for inserting the separation member 310 (i.e., the blade) into the bonded substrate 10 (S107).

For example, the processor 100 may set a position (height), which is greater than a value obtained by adding an already known known thickness d1 of a second substrate 13 to the calculated step difference Δt and smaller than a value obtained by adding the already known thickness d1 of the second substrate 13 and an already known thickness d2 of the boundary region (i.e., the bonded portion 12) to the calculated step difference Δt, as an entry position (height), and moves the separation member 310 (i.e., the blade) to the position (height) in the z-axis direction for inserting the bonded substrate 10.

When the separation member 310 (i.e., the blade) is moved to the position (height) in the z-axis direction at which the separation member 310 (i.e., the blade) may enter (be inserted into) the boundary region (i.e., the bonded portion 12) of the bonded substrate 10, the processor 100 inserts the separation member 310 (i.e., the blade) into the boundary region (i.e., the bonded portion 12) of the bonded substrate 10 to generate a crack (S108).

When the crack is generated in the boundary region (i.e., the bonded portion 12) of the bonded substrate 10, the processor 100 separates the second substrate 13 by suctioning and pulling the second substrate 13 upward using a lifting portion 30 and a plurality of suction portions 20, and then unloads a first substrate 11 and the second substrate 13 according to a specified order (S109 and S110).

In this way, in the present embodiment, by simultaneously performing the determination of damage to the separation member 310 (i.e., the blade) and the calculation of the step difference, it is possible to determine that there is no damage to the separation member 310 (i.e., the blade), and at the same time, rapidly move and insert the separation member 310 (i.e., the blade) according to a height of the bonded portion (or the boundary surface) 12, and thus a yield and work speed of a substrate separation operation can be improved through the rapid substrate separation.

According to one aspect of the present invention, the present invention can rapidly find an exact location of a bonded portion (or a boundary surface) to allow entry of a separation member, and prevent damage to an entry portion (e.g., an entry surface) as much as possible (e.g., not rough but smooth) when the separation member enters the bonded portion (or the boundary surface), and thus a yield and work speed of a substrate separation operation can be improved through stable and rapid substrate separation.

What is claimed is:

1. A substrate separation apparatus comprising:
a separation member (310) that enters a bonded portion (12) of a bonded substrate (10) in which a first substrate (11) and a second substrate (13) are bonded, and forms a crack;
a sensor module (200) configured to photograph the bonded substrate (10) and the separation member (310) to obtain measurement values corresponding to distances from the sensor module (200) to the bonded substrate (10) and the separation member (310); and
a processor (100) configured to move the separation member (310) to a height of the bonded portion (12) on the basis of the measurement values,
wherein the processor (100) sets a value, which is greater than a value obtained by adding an already known thickness (d1) of the second substrate (13) to a step difference (Δt), which is a height difference between the bonded substrate (10) and the separation member (310), and smaller than a value obtained by adding the already known thickness (d1) of the second substrate (13) and an already known thickness (d2) of the bonded portion (12) to the step difference (Δt), to be an entry height, and moves the separation member (310) thereto.

2. The substrate separation apparatus of claim 1, wherein the processor (100) calculates the step difference (Δt) on the basis of the measurement values corresponding to the distances from the sensor module (200) to the bonded substrate (10) and the separation member (310).

3. The apparatus of claim 1, wherein, in order to form the crack, the processor (100) moves the separation member (310) to the height of the bonded portion (12) and then moves the separation member (310) toward the bonded portion (12).

4. The substrate separation apparatus of claim 1, wherein the processor (100) analyzes a shape of an image of the separation member (310) captured through the sensor module (200), and, when damage to the separation member (310) occurs, immediately stops the entry of the separation member (310).

5. The substrate separation apparatus of claim 1, wherein the processor (100) simultaneously photographs the bonded substrate (10) and the separation member (310) through the sensor module (200) and calculate the step difference (Δt) between the bonded substrate (10) and the separation member (310), and at the same time, determines whether a blade of the separation member (310) is damaged.

6. The substrate separation apparatus of claim 1, wherein, in order to calculate the step difference (Δt) between the bonded substrate (10) and the separation member (310), and at the same time, determine whether a blade of the separation member (310) is damaged, the processor (100) is configured to:
move the separation member (310) in a first direction, which is a direction toward the bonded substrate (10), by a distance that allows the sensor module (200) to detect the separation member (310) and the bonded substrate (10) simultaneously; and
perform line scan measurement on the bonded substrate (10) and the separation member (310) while moving the sensor module (200) in a second direction crossing the first direction in a plan view.

7. A control method of a substrate separation apparatus, the control method comprising:
photographing, by a processor (100), a bonded substrate (10) and a separation member (310) through a sensor module (200) in order to measure distances from the sensor module (200) to the bonded substrate (10) in which a first substrate (11) and a second substrate (13) are bonded and the separation member (310);
setting, by the processor (100), on the basis of the measured distances from the sensor module (200) to the bonded substrate (10) and the separation member (310), a value, which is greater than a value obtained by adding an already known thickness (d1) of the second substrate (13) to a step difference (Δt), which is a height difference between the bonded substrate (10) and the separation member (310) and smaller than a value obtained by adding the already known thickness (d1) of the second substrate (13) and an already known thickness (d2) of a bonded portion (12) to the step difference (Δt), to be an entry height, and moving the separation member (310) to a height of the bonded portion (12) of the bonded substrate (10); and
moving, by the processor (100), the separation member (310) in a direction of the bonded portion (12) and forming a crack in the bonded portion (12).

8. The control method of claim 7, wherein, after measuring the distances from the sensor module (200) to the bonded substrate (10) and the separation member (310), the processor (100) calculates the step difference (Δt) on the basis of the measurement values corresponding to the distances from the sensor module (200) to the bonded substrate (10) and the separation member (310).

9. The control method of claim 7, wherein, after the photographing of the separation member (310), the processor (100) analyzes a shape of an image of the separation member (310) captured through the sensor module (200), and when damage to the separation member (310) occurs, immediately stops the entry of the separation member (310).

10. The control method of claim 7, wherein, in the photographing of the separation member (310), the processor (100) simultaneously photographs the bonded substrate (10) and the separation member (310) through the sensor module (200) and calculate the step difference (Δt) between the bonded substrate (10) and the separation member (310), and at the same time, determines whether a blade of the separation member (310) is damaged.

11. The control method of claim 7, wherein, after the photographing of the separation member (310), in order to calculate the step difference (Δt) between the bonded substrate (10) and the separation member (310), and at the same time, determine whether a blade of the separation member (310) is damaged, the processor (100) is configured to:
move the separation member (310) in a first direction, which is a direction toward the bonded substrate (10), by a distance that allows the sensor module (200) to detect the separation member (310) and the bonded substrate (10) simultaneously; and
perform line scan measurement on the bonded substrate (10) and the separation member (310) while moving the sensor module (200) in a second direction crossing the first direction in a plan view.
